(19) United States
(12) Patent Application Publication
(10) Pub. No.: US 2020/0320266 A1
(43) Pub. Date: Oct. 8, 2020

(54) A METHOD AND APPARATUS FOR USE IN THE ANALYSIS OF A SKIN-PRINT

(71) Applicant: INTELLIGENT FINGERPRINTING LIMITED, Cambridge (Combridgeshire) (GB)

(72) Inventors: Melanie Jane Bailey, Guildford (Surrey) (GB); William Headley, Guildford (Surrey) (GB)

(21) Appl. No.: 16/955,498

(22) PCT Filed: Dec. 18, 2018
(86) PCT No.: PCT/GB2018/053661

§ 371 Date: Jun. 18, 2020

(30) Foreign Application Priority Data
Dec. 18, 2017 (GB) 1721208.5

(51) Int. Cl. G06K 9/00

(52) U.S. Cl. CPC G06K 9/0002

(57) ABSTRACT

An apparatus for verifying the deposition of a skin-print comprises a receiving portion configured to receive a substrate associated with a unique identifier; and a skin-print deposition sensor configured to sense deposition of a skin-print on the substrate if located in the receiving portion. The apparatus further comprises: a reader configured to read the unique identifier; and a microcontroller configured: (a) to receive a signal from the skin-print deposition sensor indicative of deposition of a skin-print; (b) to associate the signal with date and time information; and (c) to associate the signal with the unique identifier provided by the reader. Also, a method of verifying the deposition of a skin-print is described.

### BACKGROUND

An impression left by the friction ridges of human skin, such as the skin of a human finger, contains information regarding the identity of the human. It is widely known that the appearance of the impression of the human finger, known as a fingerprint, is unique to each human and may be used to confirm the identity of the human. The appearance of the impression of the skin of other human body parts may also be unique to each human and so may also be used to confirm the identity of the human. Impressions of human skin, including but not limited to the skin of the human finger, may be called skin-prints.

In addition to the appearance of the impression left by human skin, the impression may contain chemical species which themselves may be detected in order to obtain further information.

For example, when a human intakes a substance (e.g. by ingestion, inhalation or injection) the substance may be metabolised by the human body giving rise to secondary substances known as metabolites. The presence of a particular metabolite can be indicative of a specific intake substance. The intake substance and/or metabolites may be present in sweat and, as such, may be left behind in a skin-print, e.g. a fingerprint. Detection of such metabolites in a skin-print can be used as a non-invasive method of testing for recent lifestyle activity such as (but not limited to) drug use, or compliance with a pharmaceutical or therapeutic treatment regime.

Importantly, the taking of a skin-print is much simpler than obtaining other body fluids such as blood, saliva and urine, and is more feasible in a wider range of situations. Not only this but since the appearance of the skin-print itself provides confirmation of the identity of the person providing the skin-print, there can be greater certainty that the substance or substances in the skin-print are associated with the individual. This is because substitution of a skin-print, particularly a fingerprint, is immediately identifiable from appearance whereas substitution of, for example, urine, is not immediately identifiable from appearance. As such, testing for one or more substances in a skin-print provides a direct link between the one or more substances and the identity of the human providing the skin-print.

The applicant has demonstrated various techniques for chemical analysis of skin-prints, including the use of mass spectrometry, for example paper spray mass spectrometry. The applicant has also developed a lateral flow skin-print analysis technique as described in WO 2016/012812, published 28 Jan. 2016.

Techniques that facilitate chemical analysis of skin-prints have a wide variety of applications. One example application may be to check for complicity with a particular dosage regime. For example, it may be expected that a quantity of a particular analyte present in a skin-print may be expected to be within predetermined bounds at a specific interval following the patient taking the drug. In the event that the quantity of analyte measured by the chemical analysis is outside the predetermined bounds at the requisite testing time, this may indicate that the patient has deviated from the dosage regime (e.g. the quantity of drug and/or the timing of the dose).

Another application may be to confirm that there are no analytes present in a skin-print that would indicate that the user has taken a dose of a specific substance, such as one that might impair their ability to perform a particular function (e.g. a narcotic).

In both of these example applications, and in others, it may be important to be able to confirm the time at which the skin-print was deposited in order to reduce the potential for fraudulent use.

For example, there may be a desire to confirm that a user has not deposited a “clean” skin-print sample at a time when they are confident of a particular result, with the intention of asserting that the sample related to a different time when they may be less confident of obtaining that result. In another example, there may be a desire to confirm that a user who may be required to provide one skin-print sample per day over a period of 28 days has not in fact deposited all 28 skin-prints on one day.

The desire to confirm that timing of specific skin-print deposition events occur in accordance with a particular predefined schedule may be especially appropriate where deposition of skin-prints is unsupervised, such as in the home rather than in a clinic.

Accordingly, a need exists for a technique to provide evidence of the timing of deposition of a skin-print.

### STATEMENTS OF INVENTION

Against this background there is provided an apparatus for verifying the deposition of a skin-print, the apparatus comprising:
a receiving portion configured to receive a substrate associated with a unique identifier;
a skin-print deposition sensor configured to sense deposition of a skin-print on the substrate if located in the receiving portion;
a reader configured to read the unique identifier; and
a microcontroller configured:
(a) to receive a signal from the skin-print deposition sensor indicative of deposition of a skin-print;
(b) to associate the signal with date and time information; and
(c) to associate the signal with the unique identifier provided by the reader.

In this way, it is possible to link a specific substrate with a time and date on which the skin-print deposition event takes place. Advantageously, this avoids the ability of users to substitute skin-print substrates. Furthermore, it avoids the possibility of a user providing an earlier deposited skin-print in place of a later one, or vice versa. These advantages reduce the opportunities for distorting a conclusion or conclusions reached from a result or set of results.

There is also provided a method of verifying the deposition of a skin-print, the method comprising:
depositing a skin-print on a substrate associated with a unique identifier;
using a skin-print deposition sensor to sense the deposition of a skin-print on the substrate and provide a signal indicative of deposition of a skin-print on the substrate;
using a reader to read the unique identifier;
associating the signal provided by the skin-print deposition sensor with:
(i) the unique identifier provided by the reader; and
(ii) date and time information concurrent with the deposition of a skin-print on the substrate.

Again, in this way, it is possible to link a specific substrate with a time and date on which the skin-print deposition event takes place. Advantageously, this avoids the ability of users to substitute skin-print substrates. Furthermore, it avoids the possibility of a user providing an earlier deposited skin-print in place of a later one, or vice versa. These advantages reduce the opportunities for distorting a conclusion or conclusions reached from a result or set of results.

### BRIEF DESCRIPTION OF THE DRAWINGS

Specific embodiments of the disclosure will now be described, by way of examples only, with reference to the accompanying drawings in which:

FIG. 1 is a highly schematic drawing of a first embodiment of an apparatus for verifying the deposition of a skin-print, in accordance with the disclosure;

FIG. 2 shows the embodiment of FIG. 1 in use with a skin-print substrate assembly and a user's finger being applied to the substrate to apply a skin-print;

FIG. 3 is a flow chart showing a process of operation of the apparatus of FIG. 1;

FIG. 4 is a highly schematic drawing of a second embodiment of an apparatus for verifying the deposition of a skin-print, in accordance with the disclosure;

FIG. 5 shows the embodiment of FIG. 2 in use with a skin-print substrate assembly and a user's finger being applied to the substrate to apply a skin-print; and

FIG. 6 is a flow chart showing a process of operation of the apparatus of FIG. 4.

### DETAILED DESCRIPTION

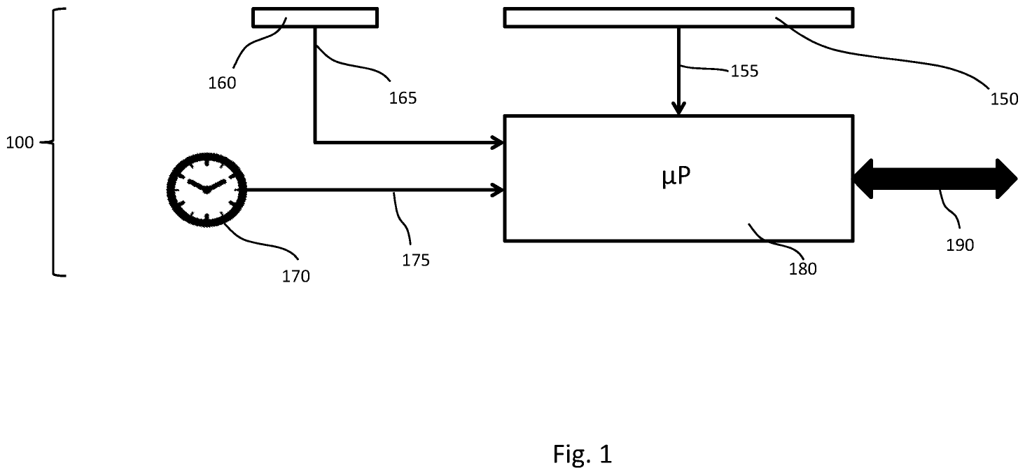

A first embodiment of an apparatus 100 for verifying the deposition of a skin-print, in accordance with the disclosure, is shown in FIG. 1.

The apparatus 100 comprises a skin-print deposition sensor 150, an RFID tag reader 160, a clock 170, a microprocessor 180, and a data output function 190. The apparatus 100 further comprises a first communication link 155 between the deposition sensor 150 and the microprocessor 180, a second communication link 165 between the RFID reader 160 and the microprocessor 180, and a third communication link 175 between the clock 170 and the microprocessor 180.

In alternative embodiments, one or more of the clock 170, the RFID reader 160 and the deposition sensor 150 may be directly mounted on the microprocessor 180 or may be an integral part of the microprocessor 180.

The apparatus 100 is configured so as to receive a skin-print substrate assembly 200 in a receiving portion of the apparatus 100. The apparatus 100 and the skin-print substrate assembly 200 each have complimentary features that mean that when the skin-print substrate assembly 200 is located in cooperation with the apparatus 100, the skin-print receiving region 230 of the substrate 210 is located sufficiently proximate to the deposition sensor 150 to enable the deposition sensor 150 to detect the deposition of a skin-print on the skin-print receiving region 230 of the substrate 210. Similarly, the complimentary features mean that when the skin-print substrate assembly 200 is located in cooperation with the apparatus 100 the RFID tag is located sufficiently proximate the RFID reader 160 to allow the RFID reader 160 to read the unique identifier from the RFID tab 240.

Detection of a deposition results in the time of the actuation being captured from the clock 170 and both the unique identifier and the time of deposition is linked within the microprocessor and stored in memory and/or transmitted off the microprocessor via the data output function 190.

The data output function 190 may be a wired connection or a wireless connection. Alternatively, there may be means for downloading the data such as via a USB memory card or other portable media. In a preferred embodiment, the data output function may comprise a wireless link to an external network which allows for the data to be transmitted to a remote server for storage and/or analysis.

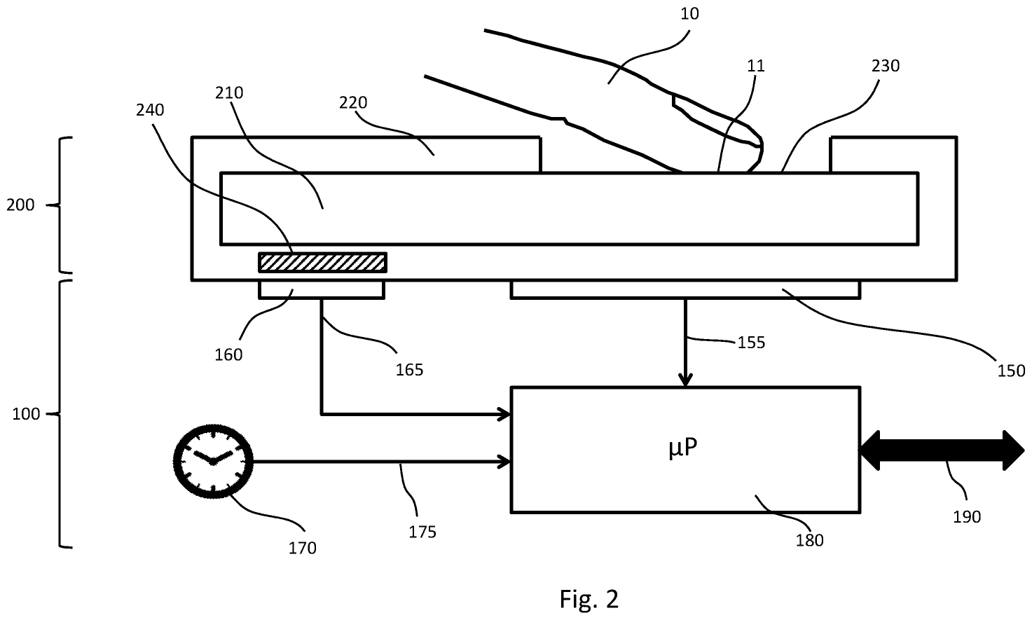

FIG. 2 shows the embodiment of FIG. 1 in use with a skin-print substrate assembly 200. The skin-print substrate assembly 200 comprises a housing 220, containing a skin-print substrate 210 including a skin-print receiving region 230. The skin-print substrate assembly 200 further comprises an RFID tag 240.

The skin-print receiving region 230 may be bounded by an opening in the housing 220, wherein the opening may be sized appropriately for the deposition of a skin-print.

FIG. 2 also shows a finger 10 being applied to the skin-print receiving region 230 so as to deposit a skin-print 11 at the interface between the fingertip and the skin-print receiving region 230.

The apparatus 100 and skin-print substrate assembly 200 are so designed such that the skin-print deposition sensor 150 is located and configured to actuate when a skin-print is deposited on the skin-print receiving region 230.

Various different options are envisaged for the skin-print deposition sensor 150 and fall within the scope of the disclosure. The skin-print deposition sensor 150 is configured to actuate when a skin-print is deposited in the skin-print receiving region 230 of the substrate 210. It may be that the skin-print deposition sensor 150 is configured to actuate only when the deposited skin-print is deposited with sufficient force/pressure as to be likely to result in a meaningful quantity of skin-print being deposited. A meaningful quantity may be a quantity that is sufficient for a subsequent analysis of the skin-print, such as a chemical analysis or an optical analysis.

In one embodiment, the skin-print deposition sensor 150 may be a capacitive sensor. In another embodiment, the skin-print deposition sensor 150 may be an optical sensor. In yet another embodiment, the skin-print deposition sensor 150 may be a pressure sensor. In a still further embodiment, the skin-print deposition sensor 150 may be a conductive sensor. Still further alternatives are possible and envisaged and would fall within the scope of the disclosure.

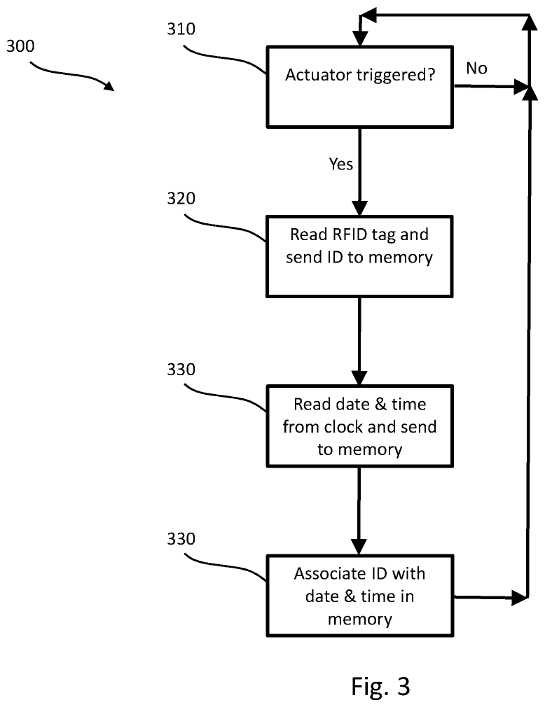

FIG. 3 is a high level flow chart 300 demonstrating use of the apparatus 100 of the first embodiment. The microprocessor 180 is configured to receive a signal via the first communication link 155 when the skin-print deposition sensor 150 is triggered, as illustrated in step 310. On triggering of the skin-print deposition sensor 150, at step 320, the microprocessor 180 retrieves a unique identifier from the RFID tag 240 associated with the skin-print substrate assembly 200 by using the RFID sensor 160. At the same time, on triggering of the skin-print deposition sensor 150, at step 330, the microprocessor 180 retrieves the time and date from the clock 170. The microprocessor 180 associates the unique identifier with the time and date at step 340. The associated unique identifier with the time and date may be stored together as associated data in memory.

The associated data may be obtained from the apparatus via the data output function 190. The data output function 190 may output each package of associated data separately. Alternatively, it may output a consolidated group of associated data, perhaps at a set frequency, such as once per day or three times per week.

Various different options are envisaged for the data output function 190. The data output function 190 may be a part of or separate from the microprocessor 180. The data output function 190 may comprise a communications module. The communications module may allow for two way communication, enabling not only the data output function but also a data input function. The data input function may in some embodiments allow for an external clock signal to be provided in lieu of or as a check for a local clock on the apparatus 100.

For example, the data output function 190 may be a wireless connection such as a WiFi connection, a cellular connection, a Bluetooth connection or any other appropriate connection using wireless technology. The wireless connection may be to a local device such as a PC, tablet or smartphone, or may be via a router, switch or cellular transceiver to a remote server. In other examples, the data output function 190 may be a wired connection, for example to a PC or tablet, from which data may be transmitted onward by other means.

The data output function 190 may allow for one way or two way communication. In the case of one way communication, the data may be output from the apparatus in accordance with a defined time schedule or in in accordance with a number of skin-print depositions, such as 1 or more than 1. In the case of two-way communication, the data may be sent in response to receipt of an instruction received from an external source via the data output function 190. Of course, a combination may be possible whereby data is output from the apparatus in accordance with a schedule and may, in addition, be sent on request from an external source.

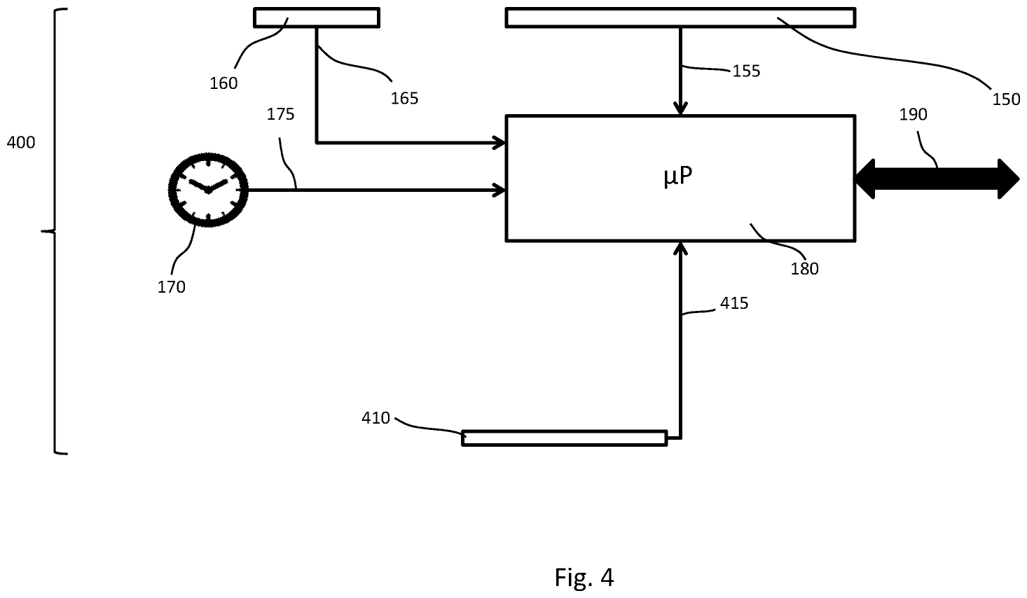

A second embodiment of an apparatus 400 for verifying the deposition of a skin-print, in accordance with the disclosure, is shown in FIG. 4. The apparatus 400 of the second embodiment may have all of the features and functionality of the apparatus 100 of the first embodiment plus additional features and functionality as described below. The features and functionality of the second embodiment of the apparatus 400 that are in common with those of the first embodiment of the apparatus 100 are shown with like reference numerals.

Accordingly, like the apparatus 100 of the first embodiment, the apparatus 400 of the second embodiment comprises a skin-print deposition sensor 150, an RFID tag reader 160, a clock 170, a microprocessor 180, and a data output function 190. The apparatus 400 further comprises a first communication link 155 between the deposition sensor 150 and the microprocessor 180, a second communication link 165 between the RFID reader 160 and the microprocessor 180, and a third communication link 175 between the clock 170 and the microprocessor 180.

Additionally, the apparatus 400 of the second embodiment further comprises a skin-print imager 410 and a fourth communication link 415 between the skin-print imager 410 and the microprocessor 180.

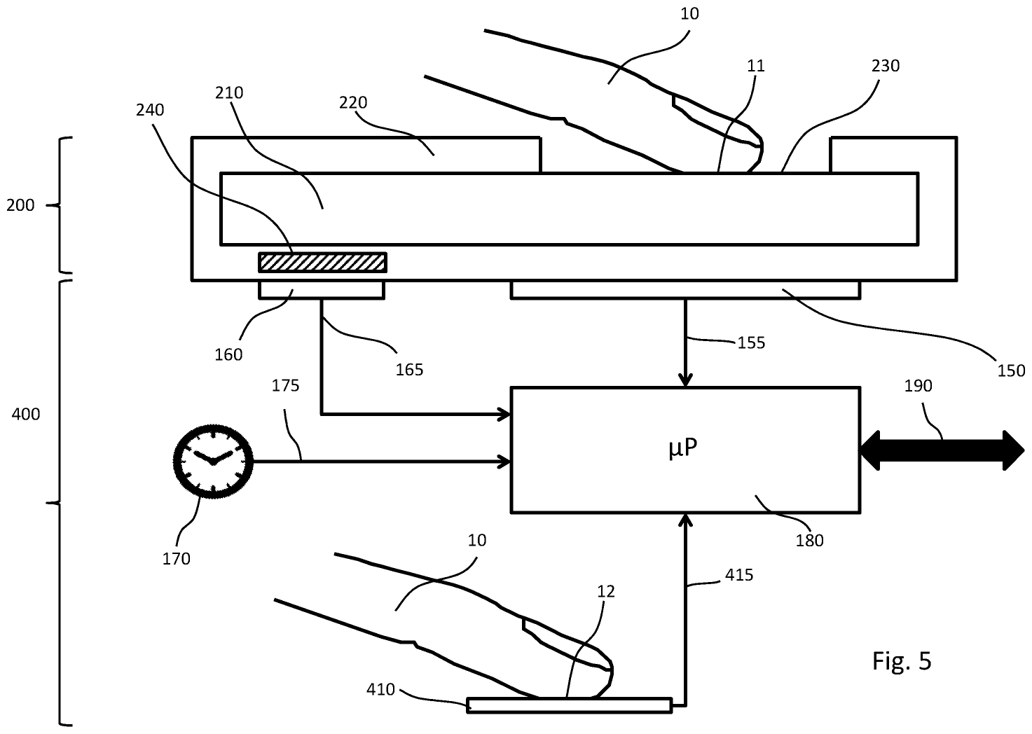

FIG. 5 shows the embodiment of FIG. 4 in use with a skin-print substrate assembly 200. This is the same as for the embodiments of FIGS. 1 and 2.

In addition, FIG. 5 shows the embodiment of FIG. 4 in use with a user applying a skin-print not only to the skin-print receiving region 230 of the substrate 210 but also to the skin-print imager 410. The skin-print 12 applied to the skin-print imager 410 may be from a different piece (e.g. a different finger) of the user's skin compared with that applied to the skin-print receiving region 230 (in which case the two skin-prints may be applied either serially or simultaneously). Alternatively, skin-print 12 applied to the skin-print imager 410 may be of the same piece of the user's skin (e.g. the same finger), in which case the two skin-prints 11, 12 would be applied serially.

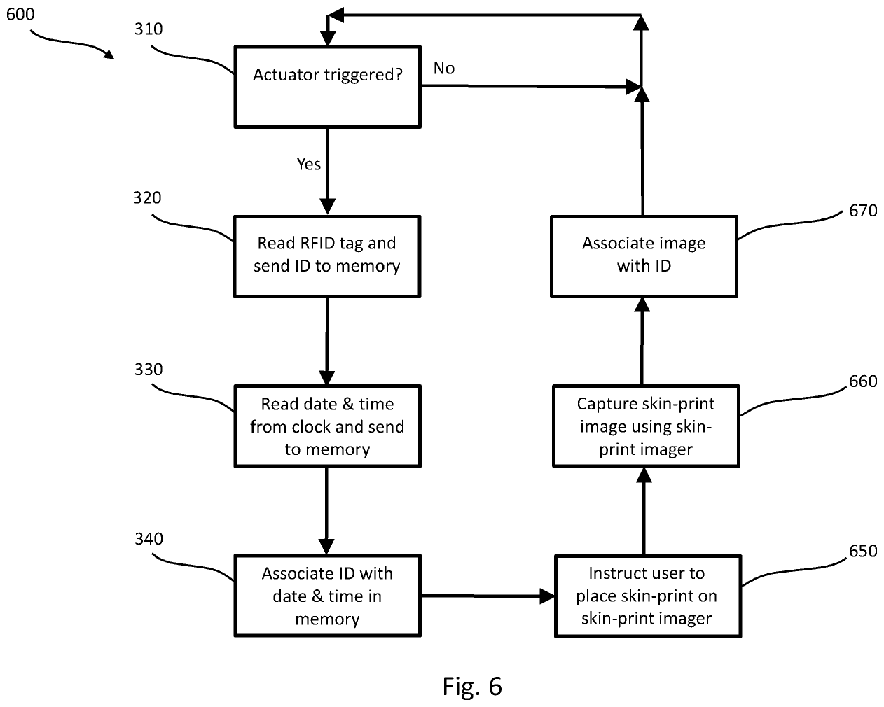

FIG. 6 is a high level flow chart 600 demonstrating use of the apparatus 400 of the second embodiment. The microprocessor 180 is configured to receive a signal via the first communication link 155 when the skin-print deposition sensor 150 is triggered, as illustrated in step 310. On triggering of the skin-print deposition sensor 150, at step 320, the microprocessor 180 retrieves a unique identifier from the RFID tag 240 associated with the skin-print substrate assembly 200 by using the RFID sensor 160. At the same time, on triggering of the skin-print deposition sensor 150, at step 330, the microprocessor 180 retrieves the time and date from the clock 170. The microprocessor 180 associates the unique identifier with the time and date at step 340. The associated unique identifier with the time and date may be stored together as associated data in memory.

In addition to the functionality of the apparatus 100 of the first embodiment, the microprocessor 180 may also be configured to instruct a user to place a skin-print on the skin-print imager 410 at step 650. Further, the microprocessor may confirm the presence of a skin-print on the imager 410 (not explicitly shown in the flowchart). The microprocessor 180 may then trigger the capture of an image of the skin-print 12 using the skin-print imager 410 at step 660. Next, at step 670, the microprocessor 180 associates the unique identifier with the captured image.

The skin-print imager 410 may comprise an optical imager, such as a charge coupled device (CCD), a capacitive scanner or any other suitable feature for obtaining a profile of the appearance of the skin-print when in contact with the skin-print imager. It is clear to the skilled person that the imager need not be of a kind that produces a conventional optical image. For example, in the case of a capacitive scanner, a matrix of capacitors is used to obtain a three-dimensional capacitance map resulting from the presence of the skin-print. In that case, the three-dimensional capacitance map may form the output of the skin-print imager 410. Alternatively, the three-dimensional capacitance map may be processed into processed image data which may form the output of the skin-print imager 410.

While the flowchart 600 of FIG. 6 shows the additional functionality of the second embodiment (steps 650, 660, 670) occurring after the functionality of the first embodiment (steps 310, 320, 330, 340) it is entirely possible for the two sets of functionality to be performed in a reverse order to that shown. Where that is the case, it may be that the actuator triggered step 310 may be that the process is initiated by a user placing a skin-print on the imager (e.g. step 650) rather than being invited to do so following step 340.

Alternative orders of the various steps (including some of the steps taking place concurrently) are within the scope of the disclosure and the appended claims.

While the specific embodiments of FIGS. 1 and 4 use of an RFID reader 160 for reading a unique identifier from an RFID tag 140, other means for storing and reading a unique identifier are envisaged and fall within the scope of the disclosure. For example, the unique identifier may be a bar code or a QR code or similar, which may be read by a regular bar code or QR code reader or by a camera. The unique identifier must not be easily separable from the substrate on which the skin-print is deposited, such that the opportunity for substitution is reduced. Where the unique identifier is located in the housing 220 of the skin-print substrate assembly 200, the skin-print substrate assembly 200 may comprise tamper evident features that provide evidence that a substrate 210 has become separated from the housing 220. Preferably, the unique identifier may be intrinsically linked to the substrate 210. This may be achieved in the case of an RFID tag by embedding the tag in the substrate 210. In the case of a bar code or QR code, the code may, for example, be etched into the substrate 210.

In some embodiments, the clock 170 may be an intrinsic element of the microcontroller 180. This may reduce a risk of intervention by one seeking to alter the clock signal.

In alternative embodiments, the date and time information may be provided by a clock (such as a universal clock signal) that is located remote from the apparatus. This information may be received by a communications module of the apparatus.

In some embodiments, the unique identification feature may comprise read/write memory. In such embodiments, the apparatus may be is configured to upload the date and time information to the read/write memory. In this way, the date and time information may then be intrinsically linked to the unique identifier that is itself linked to the substrate. In this way the date and time information may be linked physically to the substrate instead of or in addition to being linked to the substrate via memory in the microprocessor or via a database that receives data from the apparatus.

1. An apparatus for verifying the deposition of a skin-print, the apparatus comprising:
a receiving portion configured to receive a substrate associated with a unique identifier;
a skin-print deposition sensor configured to sense deposition of a skin-print on the substrate if located in the receiving portion;
a reader configured to read the unique identifier;
a microcontroller configured:
(a) to receive a signal from the skin-print deposition sensor indicative of deposition of a skin-print;
(b) to associate the signal with date and time information; and
(c) to associate the signal with the unique identifier provided by the reader.

2. The apparatus of claim 1 further comprising a clock configured to provide the date and time information.

3. The apparatus of claim 1 further comprising a communications module configured to receive date and time information from an external source.

4. The apparatus of any preceding claim wherein the skin-print deposition sensor is configured to sense the application of a force onto the substrate if located in the receiving portion.

5. The apparatus of any preceding claim wherein the skin-print deposition sensor comprises a capacitive sensor.

6. The apparatus of any preceding claim wherein the skin-print deposition sensor comprises an image sensor, such as a camera.

7. The apparatus of any preceding claim wherein the skin-print deposition sensor comprises electrical circuitry configured to detect a change in electrical properties in the substrate if located in the receiving portion.

8. The apparatus of any preceding claim wherein the receiving portion is configured to receive a skin-print substrate assembly comprising the substrate.

9. The apparatus of claim 8 wherein the skin-print substrate assembly comprises the unique identifier.

10. The apparatus of any preceding claim wherein a unique identification feature comprises the unique identifier.

11. The apparatus of claim 10 wherein the unique identification feature is or comprises a radio frequency identification (RFID) tag.

12. The apparatus of any preceding claim wherein the unique identification feature comprises read/write memory and wherein the apparatus is configured to upload the date and time information to the read/write memory.

13. The apparatus of any preceding claim wherein the reader is or comprises an RFID tag reader.

14. The apparatus of any preceding claim wherein the unique identification feature or, where present, the unique identifier is or comprises a bar code or a QR code.

15. The apparatus of claim 14 when dependent upon claim 6 or any claim dependent upon claim 6 wherein the image sensor is configured to sense the deposition of a skin-print on the substrate if located in the receiving portion simultaneously with sensing the bar code or QR code.

16. The apparatus of any preceding claim wherein the microcontroller comprises a data output function configured to transmit a package of data including the unique identifier and the concurrent date and time information associated with the deposition event.

17. The apparatus of any preceding claim further comprising a skin-print imager configured to capture an image of a second skin-print, wherein the second skin-print is deposited on the skin-print imager.

18. The apparatus of claim 17 wherein the microcontroller is configured to associate the captured image with one or more of the following:
the date and time information; and
the unique identifier provided by the reader.

19. A method of verifying the deposition of a skin-print, the method comprising:
depositing a skin-print on a substrate associated with a unique identifier;
using a skin-print deposition sensor to sense the deposition of a skin-print on the substrate and provide a signal indicative of deposition of a skin-print on the substrate;
using a reader to read the unique identifier;
associating the signal provided by the skin-print deposition sensor with:
(i) the unique identifier provided by the reader; and
(ii) date and time information concurrent with the deposition of a skin-print on the substrate.

20. The method of claim 19 further comprising the step of:
using a skin-print imager to capture an image of a second skin-print.

21. The method of claim 20 further comprising the step of:
associating the captured image with one or both of:
the date and time information; and
the unique identifier provided by the reader.

22. The method of any of claims 19 to 21 further comprising the step of transmitting a package of data including the unique identifier and the concurrent date and time information associated with the deposition event to a server.

23. The method of claim 22 when dependent directly or indirectly on claim 20, wherein the package of date further includes the captured image.

24. The method of any of claims 19 to 23 further comprising the step of writing the date and time information concurrent with the deposition of a skin-print on the substrate to the unique identifier.
